(19) United States
(12) Patent Application Publication
(10) Pub. No.: US 2009/0104387 A1
(43) Pub. Date: Apr. 23, 2009

(54) PROCESS AND APPARATUS FOR DRYING AND CURING A CONTAINER COATING AND CONTAINERS PRODUCED THEREFROM

(75) Inventors: Dennis Postupack, Alpharetta, GA (US); Sterling Steward, Douglasville, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 12/107,123

(22) Filed: Apr. 22, 2008

Related U.S. Application Data
(60) Provisional application No. 60/914,239, filed on Apr. 26, 2007.

(51) Int. Cl. B32B 1/02; B05D 3/00; B05D 3/06; B05C 11/00; B05D 3/02; B32B 38/00

(52) U.S. Cl. 428/34.6; 427/384; 427/541; 427/542; 427/379; 156/280; 427/389.7; 427/557; 118/66; 156/390; 118/642

(57) ABSTRACT

The present invention generally relates to apparatus and methods of coating glass containers and the containers produced therefrom. In particular, embodiments of the invention provide a method of coating glass containers by at least partially drying and/or curing one or more organic coatings on a glass container using accelerated drying.

### CROSS-REFERENCE TO RELATED APPLICATIONS

The present application claims the benefit of U.S. Provisional Application No. 60/914,239, filed Apr. 26, 2007, the disclosure of which is incorporated herein by reference in its entirety.

### FIELD OF THE INVENTION

The present invention relates to an apparatus for coating containers, methods of coating containers, and the containers produced therefrom. In particular, the present invention relates to an apparatus and method for drying and/or curing coatings on containers using infrared energy and/or microwave energy.

### BACKGROUND OF THE INVENTION

It is commonly known that many types of containers may be cleaned, refilled, and resold after their initial use. Reuse of such containers reduces waste and often is more cost-effective for manufacturers. Refillable containers must be able to withstand cleaning in caustic solutions, desirably maintaining both structural integrity and appearance for at least 25 cycles.

In general, glass containers undergo a number of coating steps to enhance their performance (e.g., hot end coating and/or cold end coatings). The hot end coating of metal oxides (e.g., tin, titanium, vanadium, or zirconium) typically is applied immediately following forming of the glass container at a temperature in the range of about 550° C. to 650° C. The glass containers then are heated and cooled slowly in an annealing lehr to avoid stress damage to the glass containers. Upon exiting the annealing lehr, a primer (cold end) coating may be applied to the glass containers. Lastly, the protective organic coating on the glass containers may be applied, dried, and cured in either separate or simultaneous steps.

The step of drying a protective organic coating generally requires suspending the glass container until all of the moisture has been removed, thereby avoiding contact between the wet coating on the surface of the glass container and the conveyor belt. The drying step can require exposing the glass containers to temperatures of about 100° C. for 8 to 10 minutes. In addition, the protective organic coating also must be cured in order to cross-link the coating. The curing step can require exposing the glass containers to temperatures of about 170° C. to 195° C. for 15 to 55 minutes.

The conventional coating process requires significant time for drying, preventing the glass containers from being placed on a decorating lehr belt until a sufficient amount of the moisture is removed from the protective organic coating. Accordingly, there is a need for a coating method that increases durability of the glass container while decreasing the manufacturing time for making the glass container.

### SUMMARY OF THE INVENTION

Embodiments of the present invention address the above-described needs by providing a method for coating glass containers comprising the steps of obtaining a formed glass container having a primer coating thereon; optionally pre-heating the glass container; applying a protective organic coating to the glass container; optionally pre-heating the glass container; at least partially drying the protective organic coating on the glass container using accelerated drying; and thereafter curing the protective organic coating on the glass container. The method may further comprise the step of cooling the at least partially dried protective organic coating prior to the step of curing the protective organic coating on the glass container.

Particular embodiments of the present invention also provide an optional first pre-heating zone for pre-heating the glass container; an apparatus for coating glass containers comprising an organic coating applicator for applying a protective organic coating onto the surface of a glass container; an optional second pre-heating zone for pre-heating the glass container; an accelerated drying zone for at least partially drying the protective organic coating on the glass container; a cooling zone; and a curing zone for curing the at least partially dried protective organic coating on the glass container.

Also encompassed in embodiments of the present invention are coated returnable glass containers produced by the method for coating glass containers provided herein.

Objects and advantages of the invention will be set forth in part in the following description, or may be obvious from the description, or may be learned through practice of the invention. Unless otherwise defined, all technical and scientific terms and abbreviations used herein have the same meaning as commonly understood by one of ordinary skill in the art to which this invention pertains. Although methods and compositions similar or equivalent to those described herein can be used in practice of the present invention, suitable methods and compositions are described without intending that any such methods and compositions limit the invention herein.

### BRIEF DESCRIPTION OF THE DRAWINGS

FIG. 1 is a schematic illustration of a method of coating glass containers according to a first particular embodiment of the invention.

FIG. 2 is a schematic illustration of a method of coating glass containers according to a second particular embodiment of the invention.

FIG. 3 is an elevation view of a coated glass container made according to a particular embodiment of the invention.

FIG. 4A is a schematic illustration of a microwave oven in accordance with a particular embodiment of the invention.

FIG. 4B is a schematic illustration of a microwave oven in accordance with another particular embodiment of the invention.

FIG. 5 is a cross-sectional view of an enclosed rotating chamber of a microwave oven in accordance with a particular embodiment of the invention.

FIG. 6 is a plan view of an apparatus for coating glass containers according to a particular embodiment of the invention.

FIG. 7 is a an elevation view of a chuck for gripping glass containers according to a particular embodiment of the invention.

FIG. 8 is a plan view of an apparatus for coating glass containers according to a particular embodiment of the invention.

FIG. 9A is a cross-sectional view of an IR irradiator in accordance with a particular embodiment of the invention.

FIG. 9B is a cross-sectional view of an IR irradiator in accordance with another particular embodiment of the invention.

### DETAILED DESCRIPTION OF THE INVENTION

Reference now will be made in detail to the presently proffered embodiments of the invention. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment, can be used on another embodiment to yield a still further embodiment. Thus, it is intended that the present invention cover such modifications and variations within the scope of the appended claims and their equivalents.

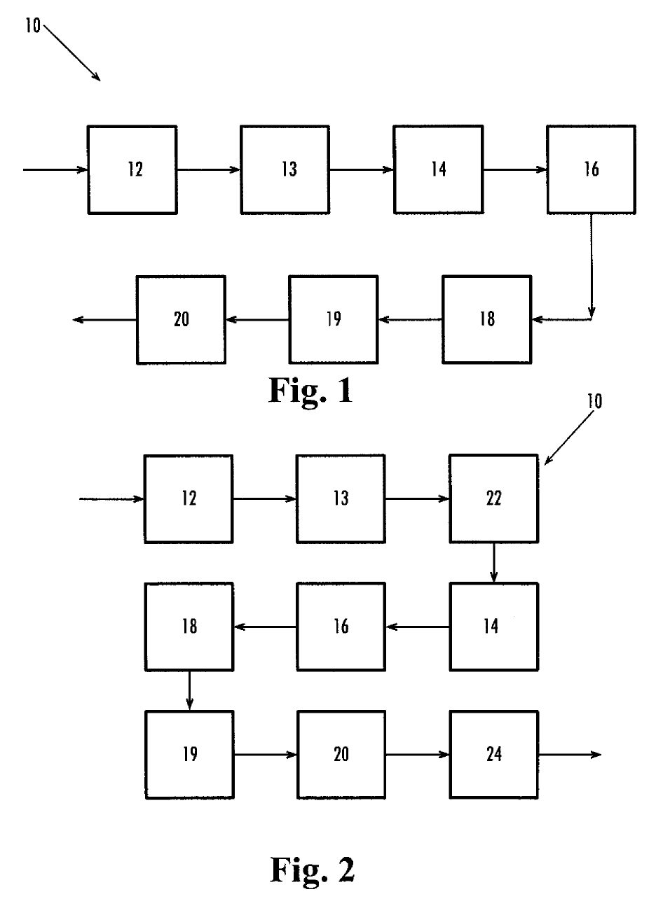

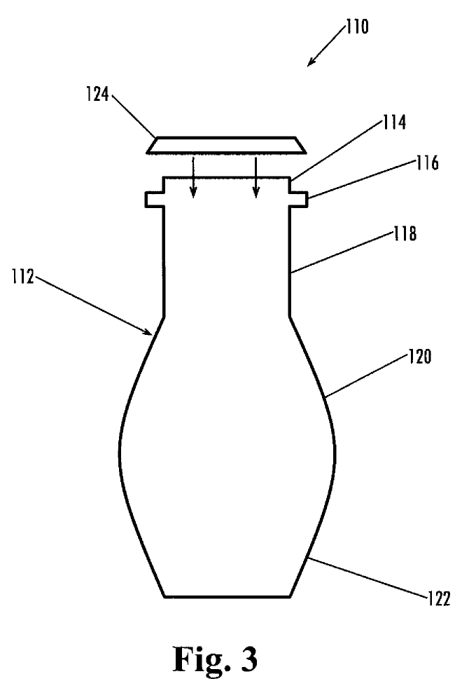

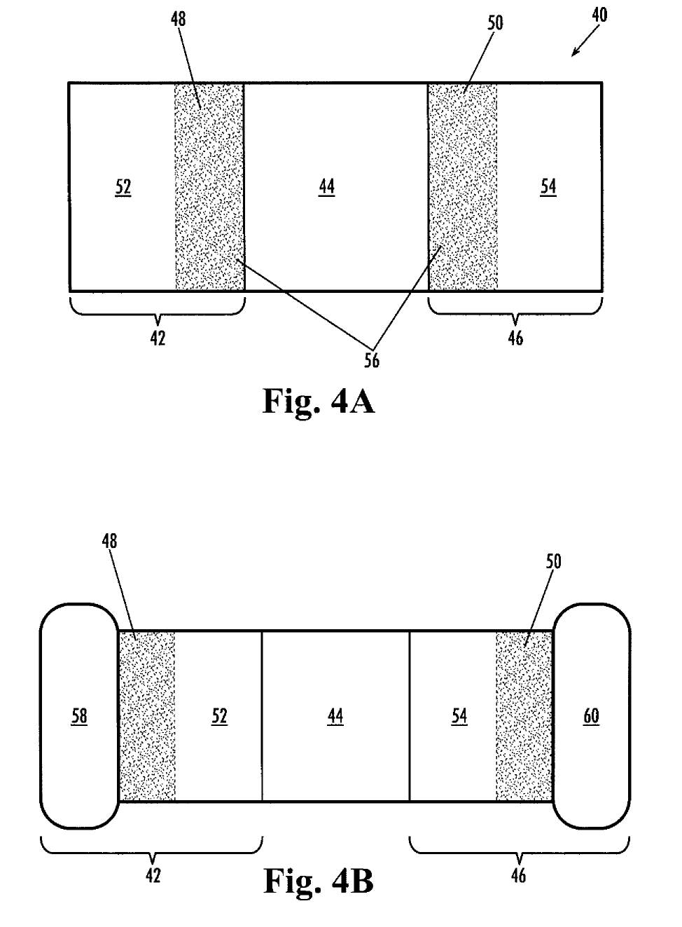

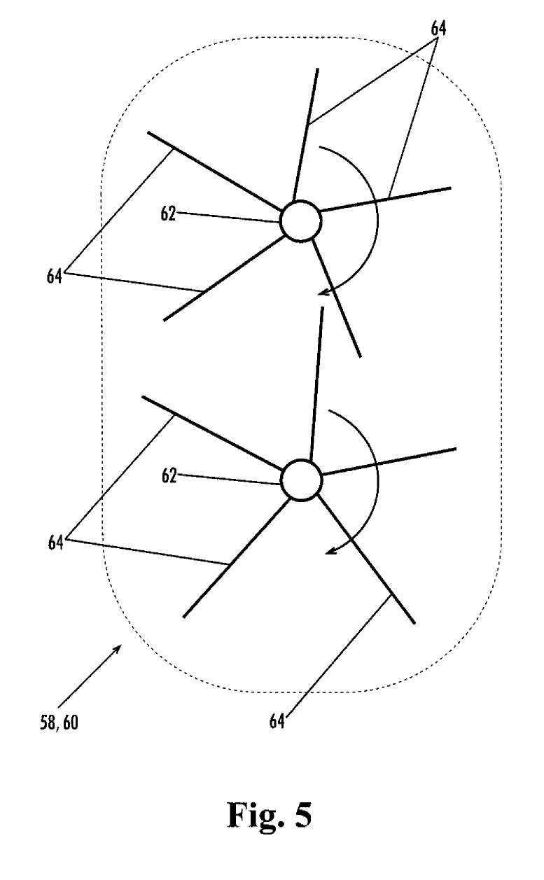

Generally described, embodiments of the present invention provide methods (FIG. 1-2) and equipment (FIG. 4-7) for coating glass containers and glass containers (FIG. 3) produced therefrom.

### I. METHOD OF COATING GLASS CONTAINERS

The methods provided herein generally provide an integrated process for coating glass containers. “Integrated”, as used herein, means a method which may be substantially completed in a single continuous process. For example, the integrated process provided herein improves upon prior art methods for coating glass containers by eliminating steps as well as by combining separate and discontinuous steps into a single continuous process. In addition, the integrated process provided herein improves upon prior art methods for coating glass containers by substantially reducing both the time and space required for coating glass containers.

In a particular embodiment, a continuous method 10 for coating formed glass containers, illustrated in FIG. 1, comprises the steps of obtaining a glass container 12 having a primer coating thereon; optionally pre-heating 13 the glass container; applying a protective organic coating 14 to the glass container; optionally pre-heating 16 the glass container; at least partially drying 18 the protective organic coating on the glass container using accelerated drying; at least partly cooling 19 the protective organic coating on the glass container; and thereafter curing 20 the protective organic coating on the glass container.

A. Coatings

i. Primer Coatings

The primer coating may be any coating that provides lubrication to protect the glass containers between the time of manufacture and the time of application of the protective organic coating and improves the adhesion of the protective coating to the glass container. In particular embodiments, the primer coating comprises both a hot end coating and a cold end coating. In other particular embodiments, the glass containers do not have a hot end coating, such that the primer coating comprises a cold end coating applied only after the containers have been substantially cooled in the annealing lehr.

In a particular embodiment, the primer coating comprises a cold end coating, the cold end coating comprising a diluted silane composition or mixture of a silane composition and a surface-treatment composition. Any silane composition suitable for use as a primer on a glass container may be used in the primer coating of the present invention, non-limiting examples of which include monoalkoxysilanes, dialkoxysilanes, trialkoxysilanes, and tetralkoxysilanes. The surface-treatment composition may comprise stearate compositions, which do not require removal prior to the addition of further coatings to the glass containers. Stearates, as used herein, comprise the salts and esters of stearic acid (octadecanoic acid). In a particular embodiment, the stearate comprises a T5 stearate coating (Tegoglas, Philadelphia, Pa.). Those of ordinary skill in the art will appreciate that the primer coating may be in the form of an aqueous solution (homogenous or colloidal) or an emulsion. The primer coating also may comprise additional compositions to improve the coating, non-limiting examples of which include surfactants and lubricants.

In another particular embodiment, the primer coating may comprise both a hot end coating and a cold end coating, the hot end coating comprising a composition suitable for adhesion to the glass containers (e.g., tin oxide) and the cold end coating comprising a stearate composition as described hereinabove. However, those of ordinary skill in the art should appreciate that generally such hot end coatings are not necessary in the embodiments provided herein.

ii. Decorative Labels

The method 10 of coating glass containers (FIG. 2) may further comprise the optional step of applying a label 22 to the glass container prior to the step of applying a protective organic coating 14 to the glass container. The label 22 may comprise any suitable label, non-limiting examples of which include pressure-sensitive labels, UV-activated labels, heat-transfer labels, and organic decorations. Those of skill in the art should appreciate that while the label 22 generally is applied to the glass container prior to the step of applying the protective organic coating 14 to the glass container, there may be particular instances in which the label 22 should be applied to the glass container after the step of applying the protective organic coating 14 to the glass container.

In particular embodiments the label comprises an organic decoration. Suitable organic decorations are well known to those of ordinary skill in the art, non-limiting examples of which include EcoBrite® Organic Ink (PPG Industries, Inc., Pittsburgh, Pa.) and SpecTruLite™ (Ferro Corporation, Cleveland, Ohio). The organic decoration may be applied to the glass container by screen printing the decoration directly onto the primer coating on the surface of the glass container. Those of ordinary skill in the art will appreciate that the selection of the organic decorative label will influence the parameters of the curing step.

iii. Protective Organic Coating

In particular embodiments of the present invention, the protective organic coating comprises polyurethane compositions designed for caustic durability. Non-limiting examples of suitable polyurethanes include hydroxyl-bearing polyurethane dispersions (e.g., Bayhydur VP LS2239, Bayer MaterialScience AG, Pittsburgh, Pa., U.S.A.), hydrophilically modified blocked polyisocyanate (e.g., Bayhydur VP LS 2240, Bayer MaterialScience AG, Pittsburgh, Pa., U.S.A.), and urethane T31M (Tsukiboshi, Japan).

The protective organic coating also may comprise additional components to enhance the performance of the coating. Non-limiting examples of suitable additives in the protective organic coating include color stabilizers, defoaming agents, surfactants, hardening and/or softening agents, adhesives, agents for improving caustic durability such as butyl rubber, epoxy, malomine, and the like.

For example, in a particular embodiment an anti-yellowing component, such as Violet T, may be added to combat any yellowing that may arise during the curing step. Violet T is a purple anthraquinone based dye which is known to those skilled in the art. The amount of Violet T that may be added to the protective organic coating may vary depending on the process conditions. For example, embodiments which require a higher curing time and temperature may require the addition of greater amounts of Violet T than in other embodiments, because the higher time/temperature combination produces a coating which is more yellow. In particular embodiments, the amount of Violet T added to the protective organic coating comprises up to about 0.15% by weight of the protective organic coating, from about 0.03 to about 0.15% by weight of the protective organic coating, from about 0.03 to about 0.10% by weight of the protective organic coating, from about 0.03 to about 0.07% by weight of the protective organic coating, or about 0.05% by weight of the protective organic coating.

Other chemical composition modifications of the protective organic coating also may be required to effectively transition from a traditional slow drying process to the accelerated drying process which is provided herein. For example, some embodiments of the protective coating composition may require an increase in the amount of the surfactant, as it has been discovered that lower amounts of surfactant which conventionally may be used may result in a severely orange peeled texture when exposed to the accelerated drying processes provided herein. It also has been discovered that by increasing the surfactant level the wetting of the protective organic coating on the glass container may be improved, thereby creating a smoother surface. In some embodiments the surfactant may be present in the protective coating in an amount from about 0.07 to about 0.3% by weight of the protective organic coating, from about 0.1 to about 0.2% by weight of the protective organic coating, or from about 0.1 to about 0.15% by weight of the protective organic coating.

In some embodiments the protective organic coating may further comprise a suitable amount of defoamer. Those skilled in the art should appreciate that the amount of defoamer that should be used may at least partially depend on the speed of the process, and that as the process speed increases the amount of defoamer required may also increase. In addition, the amount of defoamer that should be used also may depend on the mixing process being used. Surprisingly, it has been discovered that by increasing the amount of defoamer may result in a desirable decoration on the surface of the glass container. For example, in a particular embodiment increasing the defoamer resulted in an orange peel effect or water droplet effect on the surface of the glass container.

In another embodiment, the protective organic coating may comprise additional components to provide a tinted or an opaque coloring to the glass container. Such coatings may include additives such as titanium dioxide and/or a tinted or an opaque dye in amounts suitable to obtain a desired aesthetic appearance. For example, in a particular embodiment a green color may be added to the protective organic coating to give the glass container the appearance of the trademark Georgia green glass look in lieu of coloring the glass material itself. In particular embodiments such coatings may be sufficient to provide protection to the contents of the glass container against ultraviolet light (which may be particularly desirable for dairy and soy products as well as beer). In another embodiment, the contents of the glass container may be protected against ultraviolet light through a transparent coating using additives known to those of skill in the art.

Methods of applying protective organic coatings 14 to the glass container are well known to those of ordinary skill in the art. For example, the coatings may be applied by spraying, dipping, roller coating, flow-coating, or silk-screening liquid compositions to the glass containers. In addition, the thickness of the coating on the glass container may be controlled by regulating the temperature of the glass container, the temperature of the coating solution, and/or the viscosity of the coating solution. In particular embodiments, the protective organic coating has a viscosity of less than about 13 cps, less than about 12 cps, less than about 11 cps, less than about 9 cps, or less than about 8.5 cps. More particularly, the protective organic coating has a viscosity from about 8.2 to about 8.4 cps. Those of ordinary skill in the art should appreciate that the coating viscosity may be selected based on the thickness of the coating. For example, in an embodiment the protective organic coating has a viscosity of less than about 8.5 cps for a coating having a thickness of about 15 μm or a viscosity of less than about 13 cps for a coating having a thickness of about 18 μm.

In particular embodiments, the coatings have a thickness in the range of about 5 to about 40 μm, in the range of about 8 to about 30 μm, or in the range of about 15 μm to about 25 μm. Such coatings may have a weight in the range of about 1.0 to about 3.0 g per 1.25 liter bottle, more particularly in the range of about 1.5 to about 2.5 g per bottle, and still more particularly from about 1.7 to about 2.2 g per bottle. Those skilled in the art, however, should appreciate that other coating thicknesses may be used and that the amount of coating applied to the glass container generally will be determined by a cost/benefit analysis. For example, the coating thickness generally should be greater than about 10 μm to have satisfactory caustic durability while a coating thickness of up to about 25 μm will have not only superior caustic durability, but also improved abrasion resistance.

B. Pre-Heating

In particular embodiments, the method 10 of coating glass containers may further comprise the optional first and/or second step of pre-heating 13, 16 the glass containers. The first optional step of preheating 13 the glass containers may occur prior to the step of coating 14 the glass containers while the second optional step of preheating 16 the glass containers may occur prior to the step of at least partially drying 18 the coatings on the glass containers using accelerated drying.

In particular embodiments the glass containers may be pre-heated during the first optional preheating step 13 to a temperature in the range of about 30° C. to about 55° C., from about 30° C. to about 45° C., or to about 35° C. In particular embodiments the glass containers may be pre-heated during the second optional preheating step 16 to a temperature in the range of about 25° C. to about 60° C. or from about 35° C. to about 55° C.

Any suitable energy source may be used to pre-heat the glass containers during the first 13 or second optional preheating steps 16, non-limiting examples of which include thermal energy, IR radiation, and graduated levels of microwave radiation. Not wishing to be bound by any theory, it is believed that the first optional step of preheating 13 the glass containers may minimize the amount of surface moisture on the glass surface prior to coating 14 the glass containers while also warming the glass containers. In such embodiments, less energy may be required to substantially dry the coatings during the accelerated drying step 18, thereby improving the economics of process. Not wishing to be bound by any theory, it also is believed that second optional step of pre-heating 16 the glass containers accelerates the step of drying 18 and also increases the likelihood that the coatings will be free of defects that normally occur when the coatings are heated too quickly.

C. Accelerated Drying

It has been discovered that the time required for the step of at least partially drying 18 the coatings on the glass container is reduced substantially by using accelerated drying. “At least partially dried,” as used herein, means that the coatings on the glass container are dry enough to maintain the integrity of the coating through subsequent normal handling/processing of the coated glass container. The coating generally will be considered to be at least partially dried when the coating has no tackiness. In embodiments, glass containers may have a temperature at the base of the glass container in the range of about 60 to about 85° C. upon exiting the accelerated drying zone and a temperature of at least about 50° C. upon exiting the cooling zone will be free from tack.

“Accelerated drying,” as used herein, means a controlled drying process that permits removal of water from the protective organic coating to effectively at least partially dry the protective organic coating in a time period of less than about 60 seconds. More particularly, the accelerated drying may be capable of at least partially drying the protective organic coating in a period of less than about 45 seconds, less than about 30 seconds, less than about 25 seconds, less than about 20 seconds, or less than about 15 seconds. Even more particularly, the accelerated drying may be capable of at least partially drying the protective organic coating in a time period in the range of about 10 seconds to about 60 seconds. The coated glass containers generally are exposed to the accelerated drying technology at a power and for a time sufficient to partially dry the coatings of the glass containers so that the coatings maintain their integrity through subsequent handling and curing operations.

Those of skill in the art should appreciate that the drying time may be dependent on the bottle size, as small bottles generally will dry faster than larger bottles. For example, a 237 mL bottle (approximately 170 grams) may be dried in about 12 to about 15 seconds while a 1.25 L bottle (approximately 700 grams) may be dried in about 20 to about 30 seconds.

In particular embodiments the accelerated drying includes any form of electromagnetic radiation suitable for at least partially drying the protective organic coating on the glass container. Non-limiting examples of electromagnetic radiation suitable for at least partially drying the protective organic coating may include radio waves (RF), microwaves, and infrared (IR) radiation. The accelerated drying also may include any other form of drying technology that is capable of at least partially drying the protective organic coating on the glass container in a period of less than about 60 seconds (e.g., flash thermal drying).

i. Microwave Energy

“Microwave energy”, as used herein, is a form of electromagnetic radiation that comprises high frequency waves in the range of about 300 MHz to about 300 GHz with a wavelength from about 1 mm to about 1 m. Those of ordinary skill in the art will appreciate that the frequency used for partially drying the coated glass containers determines the depth at which the microwaves penetrate the surface of the coated glass containers. The government has established the standard frequencies for microwave heating of 915 MHz, 2.45 GHz, 5.8 GHz, and 28 GHz.

Those of ordinary skill in the art will appreciate that the parameters of the microwave drying process may be adjusted to prevent the formation of bubbles and other defects in the protective organic coating that may result from the coating being dried too rapidly. For example, the power required to partially dry the coated glass containers is dependent on the mass and volume of the coated glass container, the thickness of the coating on the glass container, the absorbance of the chemistry within the coating, the number of coated glass containers in the microwave oven, the temperature of the coated glass container, and the total length of time the coated glass containers are in the microwave.

Generally, the output power of the microwave is in the range of about 0.3 to about 300 kilowatts. By pre-heating the glass containers prior to the step of accelerated drying, the output power of the microwave may be decreased. For example, it has been discovered that the output power of the microwave (3 kilowatts) may be decreased by up to about 50 percent for the experimental unit used in the Examples described herein below. It also has been discovered that pre-heating of the glass containers makes the heating of the protective organic coating on the glass container more uniform during the microwave heating process, especially for larger bottles. Accordingly, it may be desirable to include an optional pre-heating step in embodiments wherein the accelerated drying technology comprises microwave energy.

In a particular embodiment, a single 237 mL coated glass container is exposed to microwaves at about 10% to about 100% of a maximum output power in the range of about 0.3 to about 3 kilowatts for a time in the range of about 1 to about 15 seconds, more particularly in the range of about 5 to about 10 seconds, and still more particularly in the range of about 6 to about 8 seconds. In a particular embodiment, the single 237 mL coated glass container is exposed to high frequency waves of about 2.45 GHz at an output power of about 2.7 kilowatts (3 kilowatts at 90% maximum power) for about 8 seconds. In another embodiment, a plurality (19) of 237 mL coated glass containers are exposed to high frequency waves of about 2.45 GHz at an output power of about 6 to about 20 kilowatts for about 8 seconds to at least partially dry the protective organic coating on the glass container.

The source of microwave energy may comprise any microwave irradiator capable of exposing the coated glass containers to microwaves, non-limiting examples of which include batch ovens, conveyor ovens, and mobile oven microwave irradiators. In particular embodiments, the source of microwave energy comprises a “hot” microwave that is maintained at a temperature in the range of about 150° C. to about 200° C., from about 160° C. to about 180° C., and even more desirably at about 170° C. Not wishing to be bound by any theory, it is believed that use of a hot microwave accelerates the kinetics of the drying process, thereby improving the efficiency of the drying process. Those of ordinary skill in the art will appreciate that the quantity, shape, and size of coated glass containers to be dried using microwave energy will influence selection of an appropriate microwave irradiator.

In a particular embodiment, the microwave oven 40 (illustrated in FIG. 4A) used in the drying step 18 is divided into three major sections, a first choke area 42, a microwave space 44, and a second choke area 46. The first 42 and second 46 choke areas prevent microwaves from leaking outside of the microwave oven 40 during the continuous process of coating glass containers. In a particular embodiment, the first 42 and second 46 choke areas are divided further into non-passive choke areas 48, 50 and passive choke areas 52, 54. The non-passive choke areas 48, 50 are adjacent to the microwave space 44 and comprise metal pieces 56 that reflect the microwaves back into the microwave space. The passive choke areas 52, 54 may comprise microwave absorbers. Such technologies are well known to those of ordinary skill in the art.

In another particular embodiment, the first 42 and second 46 choke areas of the microwave oven 40 (illustrated in FIG. 4B) used in the drying step 18 further comprise enclosed rotating chambers 58, 60. In particular embodiments, the coated glass containers enter and exit the microwave oven 40 through the enclosed rotating chambers 58, 60 which are adjacent to the non-passive choke areas 48, 50. Briefly described, the enclosed rotating chambers 58, 60 (illustrated in FIG. 5) comprise two rotating hub 62 and spoke 64 systems, wherein the hubs 62 are separated by a distance no greater than the length of the spokes 64, thereby obstructing the passage of microwaves beyond the enclosed rotating chambers 58, 60 of the microwave oven 40.

An exemplary embodiment of a microwave irradiator suitable for use with embodiments is disclosed in U.S. patent application Ser. No. 11/970,910, filed on Jan. 8, 2008, entitled “Vestibule Apparatus,” the disclosure of which is hereby incorporated by reference.

ii. IR Radiation

“IR Radiation,” as used herein, is a form of electromagnetic radiation that comprises high frequency waves greater than about 300 GHz to about 400 THz and with wavelengths from about 750 nm to about 1 mm. Those of ordinary skill in the art will appreciate that the frequency used for partially drying the coated glass containers determines the depth at which the microwaves penetrate the surface of the coated glass containers. In embodiments wherein the accelerated drying comprises IR Radiation, there generally is no need to include a separate pre-heating stage prior to the accelerated drying stage because the IR Radiation has been found to increase the temperature of the protective organic coating sufficiently to partially dry the protective organic coating.

Those of ordinary skill in the art will appreciate that the parameters of the IR radiation drying process may be adjusted to prevent the formation of bubbles and other defects in the protective organic coating that may result from the coating being dried too rapidly. For example, the power required to partially dry the coated glass containers is dependent on the mass and volume of the coated glass container, the thickness of the coating on the glass container, the absorbance of the chemistry within the coating, the temperature of the coated glass container, and the total length of time the coated glass containers are in the IR irradiator.

Generally, the IR irradiator will have a length from about 8 ft to about 24 ft, more particularly from about 10 ft to about 18 ft, and still more particularly about 12 ft. Those skilled in the art will appreciate that the shorter the IR irradiator, the higher the IR energy power required for a given line velocity. However, if the IR unit is too short (e.g., about 6 feet or less) the power may have to be increased to such an extent that it would result in the formation of defects (e.g., bubbles). Those skilled in the art will appreciate that the power output of the IR irradiator generally will depend on the length of the IR irradiator as well as the number of IR bulbs being used.

For example, in a particular embodiment a single 237 mL coated glass container is exposed to IR radiation at about 17 to about 175 kW, from about 65 to about 135 kW, or from about 76.5 to about 105 kW for a time in the range of about 5 to about 60 seconds, in the range of about 5 to about 45 seconds, or in the range of about 8 to about 20 seconds.

The source of IR radiation may comprise any IR irradiator capable of exposing the coated glass containers to IR radiation, non-limiting examples of which include batch ovens, conveyor ovens, and mobile oven IR irradiators. In particular embodiments, the source of IR radiation comprises an IR irradiator having a cavity temperature in the range of about 200° C. to about 600° C. Those of ordinary skill in the art will appreciate that the quantity, shape, and size of coated glass containers to be dried using IR radiation will influence selection of an appropriate IR irradiator.

D. Cooling

In a particular embodiment, the method 10 of coating glass containers further comprises the step of cooling 20 the at least partially dried coatings on the glass container in a cooling zone. Suitable methods of cooling are well known to those of ordinary skill in the art and include use of ambient or stagnant air or accelerated cooling techniques utilizing air nozzles or air knives. Not wishing to be bound by any theory, it is believed that accelerating the cooling of the coatings freezes (i.e., sets) the partially dried coating, thereby reducing the creation of defects during subsequent handling of the coated glass containers.

E. Glass Container Handling

In a particular embodiment, the glass containers are moved continuously throughout the coating process by a linear belt. Such belts are well known to those of ordinary skill in the art. The speed of the linear belt will depend on the volume of the glass containers. Generally, the speed of the linear belt will be in the range of about 5 inches to about 12 inches per second for glass containers having a volume in the range of about 1.5 L to about 200 mL, respectively. These speeds correspond to processing speeds of about 80 containers per minute to about 150 containers per minute, respectively. For example, in an embodiment wherein the glass containers comprise smaller containers having a volume of about 250 mL, the linear belt moves at a speed of about 12 inches per second, or about 150 containers per minute. In another embodiment wherein the glass containers comprise larger containers having a volume of about 1.5 L, the linear belt moves at a speed of about 7 inches per second or about 80 containers per minute.

The linear belt generally comprises chucks that are capable of gripping the glass containers. The chucks generally comprise an inverted guide cone for centering the opening of the glass containers and a device for holding the glass containers in place. The chucks control the rotation of the glass containers as well as the position of the glass containers (e.g., vertical, horizontal, above horizontal (hips up), or below horizontal (hips down)). Those of ordinary skill in the art will appreciate that the position and rotation of the glass container may be optimized to obtain the desired coverage and thickness of coating on the glass container. In addition, those of ordinary skill also will appreciate that in embodiments wherein the accelerated drying comprises microwave energy the linear belt and chucks should be comprised of microwave safe materials, non-limiting examples of which include Teflon, glass-filled Teflon, and PEEK.

F. Curing

The subsequent step of curing 20 the protective organic coatings on the glass containers may be performed using any suitable energy source, non-limiting examples of which include thermal, IR radiation, UV radiation, microwave radiation, RF or combinations thereof. Those of ordinary skill in the art should recognize that the energy source will directly influence the time required for curing. Those of ordinary skill in the art also should appreciate that the temperature and time of the curing step also will depend on the type of optional decorative label and the protective organic coating applied to the glass containers.

In a particular embodiment the protective organic coatings are cured in a thermal oven at a temperature in the range of about 160° C. to about 200° C. for a time in the range of about 20 to about 60 minutes. In one particular embodiment, the protective organic coatings are cured in a thermal oven at a temperature of about 185° C. for about 50 minutes. In another particular embodiment, the protective organic coatings are cured in a thermal oven at a temperature of about 180° C. for about 65 minutes.

Alternatively, the protective organic coatings may be cured in a microwave oven to reduce significantly the time required for curing as well as the space required for the equipment. For example, in a particular embodiment the space required for a microwave oven is about 18 feet (including the choking sections) as compared to the 70 feet conventional lehr. Accordingly, in a particular embodiment, the protective organic coatings can alternatively be cured by pre-heating the glass containers to a temperature in the range of about 35° C. to about 55° C. and thereafter exposing the glass containers to microwave energy for a time in the range of about 2 to about 5 minutes in a heated microwave chamber maintained at a temperature of about 170° C. Surprisingly, it has been discovered that microwave curing of the protective organic coatings on glass containers not only significantly reduces the manufacturing time, but also significantly improves the caustic durability of the glass container.

G. Oxidizing Flame

In still other particular embodiments, the method 10 of coating glass containers further comprises the step of applying an oxidizing flame 24 to reduce the wetting angle of the surface of the glass container. The oxidizing flame partially oxidizes the hydrophobic coating on the glass container, thereby creating a hydrophilic surface on the coated glass container that prevents formation of drops of water on the surface of the glass container (e.g., reducing problems with automatic visual inspection, promoting adhesion of paper labels to the surface of the coated glass container, and reducing condensation on the outer surface of glass containers filled with cold beverages in warm rooms). Methods of hydrophilicizing coated glass containers are further disclosed in Japanese Patent Publication 2003-211073, the disclosure of which is incorporated herein by reference in its entirety.

In a particular embodiment, the source of the oxidizing flame comprises off-set stacked burners on opposite sides of the glass containers. The number of burners and height of the stack of burners depend on the height of the glass container (e.g., 8 burners for each side of a 200 mL glass container). In particular embodiments, the glass containers also may be elevated over burners or placed on an open conveyor chain permitting penetration of the oxidizing flame to the bottom of the glass containers. The burners may produce a highly oxidizing (blue) flame with a temperature in the range of about 1100° C. to about 1500° C. The glass containers may be contacted with the hottest portion of the flame, generally occurring mid-way between the peak tips of the inner flame and the outer flame. Those of ordinary skill in the art will appreciate that the length of time that the glass containers are contacted with the oxidizing flame will vary depending on the mass and volume of the glass container as well as the thickness of coatings. In a particular embodiment, the glass containers are contacted with the oxidizing flame for a time in the range of about 0.5 seconds to about 15 seconds, more particularly from about 1 second to about 5 seconds. In a particular embodiment, the contact angle of the coated glass containers following the partial oxidation of the coatings is less than 350, more desirably less than 300.

### II. GLASS CONTAINERS

The glass containers for use in embodiments of the present invention may comprise any glass containers suitable for use as packaging, non-limiting examples of which include bottles, jars, vials, and flasks. In a particular embodiment, the glass container 110 comprises a glass bottle, illustrated in FIG. 3, comprising a shell 112 which include a mouth 114, a capping flange 116 below the mouth, a tapered neck section 118 extending from the capping flange, a body section 120 extending below the tapered section, and a base 122 at the bottom of the container. The container 110 may be suitably used to make a packaged beverage, comprising a beverage such as a carbonated or non-carbonated soda beverage disposed in the container 110 and a closure 124 sealing the mouth 114 of the container.

The present invention is advantageous in that it enables re-use of glass containers that normally are non-returnable. Non-returnable glass containers generally are lighter in weight than refillable glass containers. By applying a protective organic coating to the surface of non-returnable glass containers, the durability of the glass containers is enhanced without also increasing the weight of the glass container. Accordingly, this invention provides durable light weight refillable glass containers that are significantly lighter than standard returnable glass containers.

Alternatively, embodiments of the present invention may enable re-use of returnable glass containers having blemishes or other scuffs which make the glass containers unsuitable for re-use. For example, in a particular embodiment a scuffed or blemished coated returnable glass container may be coated according to embodiments of the present invention to minimize the appearance of scuffs or blemishes. Such re-coating processes may be conducted using either a mobile unit or a permanent unit. A mobile unit, as used herein, means a process facility which is capable of moving or of being moved readily from place to place while a permanent unit, as used herein, refers to equipment used at traditional process facilities which generally is not expected to change in status, condition, or place. Using a mobile unit would eliminate the need to return the glass containers to the original facility where the coating was applied. Thus, in a particular embodiment, a method is provided for obtaining a glass container having a coating that was applied at a first location and reapplying the coating at a second location using either a mobile or permanent unit.

The durability of the coated glass containers may be evaluated by measuring their burst pressure strength. In a particular embodiment, the coated glass containers are exposed to 25 cycles of a caustic wash (7 minutes each cycle) and line simulation (1 minute each cycle). The composition of the caustic wash generally comprises 2.25% (+/−0.25%) of a caustic agent (e.g., sodium hydroxide) and 0.25% anti-rust additive (BW61, JohnsonDiversey, Inc., Sturtevant, Wis., U.S.A.) at a temperature in the range of about 65° C. to about 70° C. The burst pressure strength of the coated glass containers is measured to determine the durability of the coated glass containers. The burst pressure strength of the coated glass containers should remain equivalent after 25 cycles of the caustic wash/line simulation as compared to a non-returnable glass container without a coating after 0 cycles.

The present invention also significantly reduces the number of steps and time required for the manufacture of coatings on glass containers, thereby increasing the speed of the process by nearly 50 times. Conventional drying processes generally require at least 10 minutes, as compared to the 12 to 30 seconds generally provided for by the drying processes of the present invention. Accordingly, it is believed that the present invention will increase significantly the processing speed of glass containers to about 80 to about 150 containers per minute for containers having a volume of about 1.5 L to about 200 mL, respectively. Thus, in particular embodiments the present invention will increase the processing speed for coating glass containers by about 25 to about 50 times, by about 35 to about 50 times, or by about 45 to about 50 times the time required by conventional processes.

### III. COATING APPARATUS

Embodiments of the present invention further provide an apparatus for coating glass containers. Briefly described, an apparatus for coating glass containers comprises an organic coating applicator for applying a protective organic coating to the glass container; an accelerated drying zone for at least partially drying the protective organic coating on the glass container; a cooling zone; a curing zone for curing the at least partially dried protective organic coating on the glass container; and an oxidizing zone for at least partially oxidizing the protective organic coating.

Upon application of the protective organic coating, excess solution may be eliminated from the glass container and the protective organic coating may be substantially evenly distributed on the glass container in a drip station comprising a drip zone and a coating equalization zone located between the organic coating applicator and accelerated drying zone. Those of ordinary skill in the art should appreciate that the lengths of the drip zone and coating equalization zone, position of the glass container, and rate of rotation of the glass container may be modified to minimize dripping and to optimize the distribution of the coating on the glass container. In a particular embodiment, the apparatus may further comprise a decorator for applying a decorative label to the glass container prior to applying the protective organic coating to the glass container.

After application of the protective organic coating, an accelerated drying zone at least partially dries the protective organic coating on the glass container so that the integrity of the protective organic coating on the glass container is maintained during subsequent handling of the glass container. In particular embodiments, the apparatus may further comprise a pre-heating zone for pre-heating the coated glass containers prior to the accelerated drying zone and/or a cooling zone for cooling the coated glass containers between the accelerated drying zone and curing zone.

The apparatus further comprises a conveyor belt and a plurality of chucks for continuous transport of the glass containers through the organic coating applicator and the accelerated drying zone.

A. Microwave Drying Apparatus

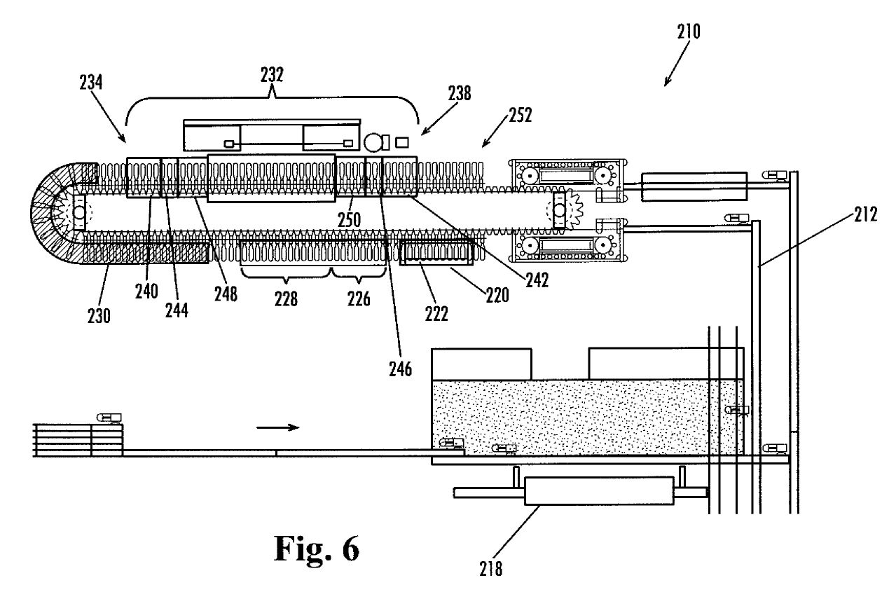

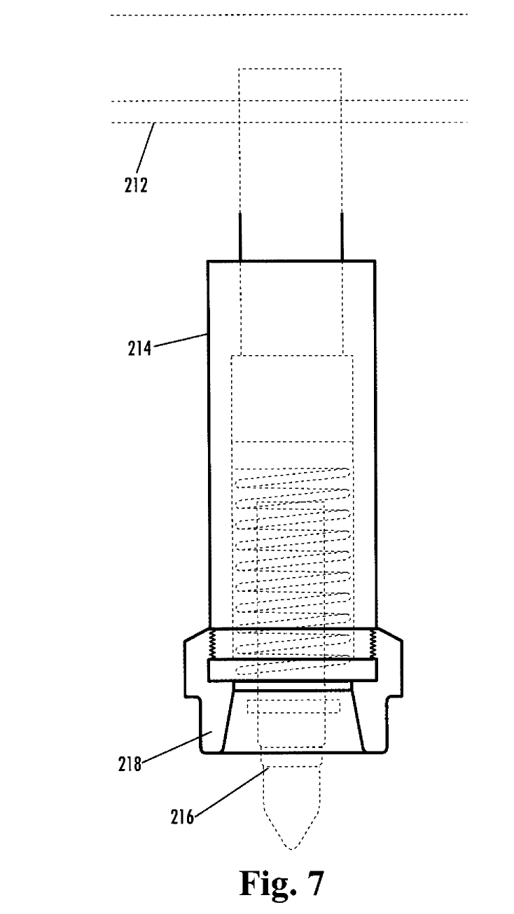

An exemplary apparatus 210 for coating small glass bottles 110 with a volume of about 237 mL in accordance with a particular embodiment of this invention is illustrated in FIG. 6, and described herein below. After exiting an annealing lehr, a primer coating comprising a stearate and silane solution (about 1% by weight silane) is applied to the glass bottles 110 by a sprayer (not pictured). Generally, the glass bottles 110 are at a temperature of about 120° C. to about 150° C. upon exiting the annealing lehr and are at a temperature of about 90° C. to about 110° C. upon application of the primer coating. The glass bottles then are palletized for transport to a separate decorating station or facility where the optional decorative label and the protective organic coating generally are concurrently applied to the glass bottles 110.

Upon receipt at the decorator, the glass bottles 110 are depalletized and positioned upright on a conveyor belt (not pictured). The glass bottles 110 then optionally may be run through a preheater to remove residual moisture from the surface of the glass bottles and to ensure the glass bottles are at a uniform temperature before the glass bottles optionally are run through a decorator 218 and an organic decorative label optionally is applied to the outer surface of the glass bottles. During the decoration process, the glass bottles 110 may be at a temperature of about 20° C. to about 50° C. Those skilled in the art should appreciate that in some embodiments in which a decorative label is not applied to the glass bottles, the decorator may be removed from the process apparatus.

Following application of the organic decorative label, the decorated glass bottles 110 then are transported continuously by a linear belt 212 to the coating system and transferred to a plurality of rotatable, microwave-compatible chucks 214. The linear belt 212 and plurality of chucks 214 comprise microwave-compatible materials, non-limiting examples of which include Teflon, glass-filled Teflon, and PEEK. The chucks 214 (illustrated in FIG. 7) comprise an inverted guide cone 216 for centering the opening of the glass bottles 110 and a device 217 for holding the glass bottles in place. The chucks 214 grip the glass bottles 110 by the neck, begin rotating the glass bottles, and invert the glass bottles to a horizontal position (not pictured). The glass bottles 110 desirably are rotated by the chucks 214 at a rate of about 15 revolutions per minute while the linear belt 212 moves at a velocity of about 1 foot per second, corresponding to about 150 bottles per minute.

The rotating glass bottles 110 are transferred to a 4 foot dip tank 220 comprising the protective organic coating 222. Upon entering the dip tank 220, the glass bottles 110 are angled below horizontal (hips down) by about 18°, such that at least half of the bottom of the glass bottle is coated. The protective organic coating 222 comprises a mixture of a polyurethane composition, a color stabilizer, a surfactant, a defoaming agent, and an adhesive agent, having a viscosity of about 6.5 to about 13 cps or about 8.5 cps. The glass bottles 110 return to horizontal upon exiting the dip tank 220. In embodiments, the protective organic coating may be continuously added to the dip tank such that the protective organic coating is overflowing the dip tank, thereby ensuring that the top edge of the coating is both uniform and at a constant height. The overflow material then may be collected in a surge tank which, with the aid of a cooling/heating unit, is capable of maintaining the protective organic coating at a generally constant temperature (e.g., 25° C.+/−5° C.). By maintaining a generally constant temperature, a uniform coating thickness and weight may be achieved on the glass bottles. This surge system also may contain a series of filters which are capable of removing debris from the protective organic coating which otherwise could result in defects in the protective organic coating on the glass bottles.

The rotating glass bottles 110 continue to a drip station 224 comprising two sections, a 4 foot drip section 226 and a 6 foot equalizer section 228. Upon entering the 4 foot drip section 226, the rotating glass bottles 110 are angled below horizontal by about 30° and the rotation of the glass bottles is stopped for about 1 to about 4 seconds to permit dripping of the excess coating 222 off the bottom of the glass bottle. The glass bottles 110 begin rotating again upon entering the 6 foot equalizer section 228 and are angled above horizontal (hips up) by about 28° to evenly distribute of the remaining coating 222 over length of the bottle. The glass bottles 110 return to horizontal upon exiting the drip station 224.

Those of ordinary skill in the art should appreciate that the speed of rotation of the glass bottles 110 may be modified according to the viscosity of the protective organic coating 222 (e.g., a slower rotation is desired for higher viscosity fluids and a faster rotation is desired for lower viscosity fluids). In addition, those of ordinary skill in the art should appreciate that the angling of the glass bottles 110 may be modified according to the shape of the glass bottle (e.g., an angle of 45° below horizontal would be most desirable to optimize removal of excess coating for a substantially cylindrical glass bottle).

The rotating coated glass bottles 110 then are pre-heated to a temperature in the range of about 35° C. to about 55° C. by an infrared radiation heat bank 230 prior to entering a hot microwave 232. The hot microwave 232 may be about 18 feet in length, and requires only 8 seconds for at least partially drying of the coatings on the glass bottles. The microwave 232 is divided into three sections: a first choke area 234 (5 feet), a microwave space 236 (8 feet), and a second choke area 238 (5 feet). The first 234 and second choke areas 238 are further divided into an enclosed rotating chamber (2 feet) 240, 242, a non-passive area 244, 246 with microwave reflectors (1 foot), and a passive area 248, 250 with microwave absorbers (2 feet). The passive areas 248, 250 of the first 234 and second choke areas 238, respectively, are adjacent to the microwave space 236 and the non-passive areas 244, 246 are between the passive areas 248, 250 and the enclosed rotating chamber 240, 242 of the first 234 and second choke areas 238, respectively. The microwave 232 may have a power frequency of 2.45 GHz, generating a total power output of about 17 kilowatts. However, those of ordinary skill in the art should appreciate that the power frequency of the microwave 232 may be modified to other suitable frequencies depending on the desired coating penetration. The microwave 232 may be maintained at a temperature of about 170° C.

Upon exiting the hot microwave 232, the glass bottles 110 are exposed to air knives or air nozzles in a cooling zone 252 wherein the at least partially dried coatings are cooled and set. The coated glass bottles 110 are subsequently inverted back to vertical and released onto a second conveyor belt which transfers the glass bottles to the thermal curing oven, where the glass containers are cured at a temperature of about 185° C. for about 50 minutes (not pictured). The curing time and temperature will vary depending on the particular coating composition and thickness. With an EcoBrite coating, for example, the containers are cured at 180° C. for 45 minutes. After curing, the glass bottles 110 then are passed through an oxidizing flame to partially oxidize the hydrophobic coatings (not pictured). The coated glass bottles 110 are then ready for filling and sealing.

B. IR Radiation Drying Apparatus

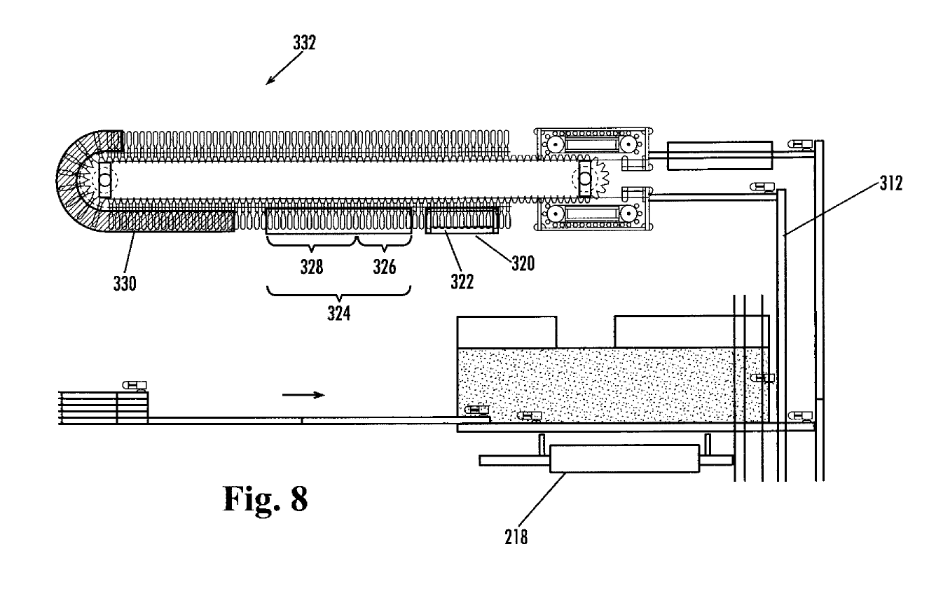

Another exemplary apparatus 310 for coating small glass bottles 110 with a volume of about 237 mL in accordance with a particular embodiment of this invention is illustrated in FIG. 8, and described hereinbelow. After exiting the annealing lehr, the primer coating, the cold end coating comprising a stearate solution (e.g., about 1% by weight stearate and about 0.2% silane, or 0% stearate and 1% silane), is applied to the glass bottles 110 by a sprayer (not pictured). Generally, the glass bottles 110 are at a temperature of about 550° C. to about 650° C. before entering the annealing lehr are at a temperature of about 120° C. to about 150° C. upon exiting the annealing lehr, and are at a temperature of about 90° C. to about 110° C. upon application of the cold end coating. The glass bottles then are palletized for transport to a separate decorating station or facility where the glass bottles optionally may be preheated before the optional decorative label and the protective organic coating are applied to the glass bottles 110 using the same processes described hereinabove.

Following application of the organic decorative label, the decorated glass bottles 110 then are transported continuously by a linear belt 312 to the coating system and transferred to a plurality of rotatable chucks 314. Unlike the apparatus comprising the microwave oven described hereinabove, the linear belt 312 and plurality of chucks 314 in the present embodiment may comprise non-microwave-compatible materials, a non-limiting example of which includes stainless steel. The chucks 314 are otherwise the same as the apparatus described hereinabove. The glass bottles 110 may be rotated by the chucks 214 at a rate of about 15 revolutions per minute while the linear belt 212 moves at a velocity of about 1 foot per second, corresponding to about 150 bottles per minute.

The rotating glass bottles 110 are transferred to a 4 foot dip tank 320 comprising the protective organic coating 322. Upon entering the dip tank 320, the glass bottles 110 are angled below horizontal (hips down) by about 18°, such that at least half of the bottom of the glass bottle is coated. The protective organic coating 322 comprises a polyurethane composition, a color stabilizer, a surfactant, a defoaming agent, and an adhesive agent having a viscosity of about 8.2 to about 8.4 cps. The glass bottles 110 return to horizontal upon exiting the dip tank 320.

The rotating glass bottles 110 continue to a drip station 324 comprising two sections, a 4 foot drip section 326 and a 6 foot equalizer section 328. Upon entering the 4 foot drip section 326, the rotating glass bottles 110 are angled below horizontal by about 30° and the rotation of the glass bottles is stopped for about 1 to about 4 seconds to permit dripping of the excess coating 322 off the bottom of the glass bottle. The glass bottles 110 begin rotating again upon entering the 6 foot equalizer section 328 and are angled above horizontal (hips up) by about 28° to evenly distribute of the remaining coating 322 over length of the bottle. The glass bottles 110 return to horizontal upon exiting the drip station 324.

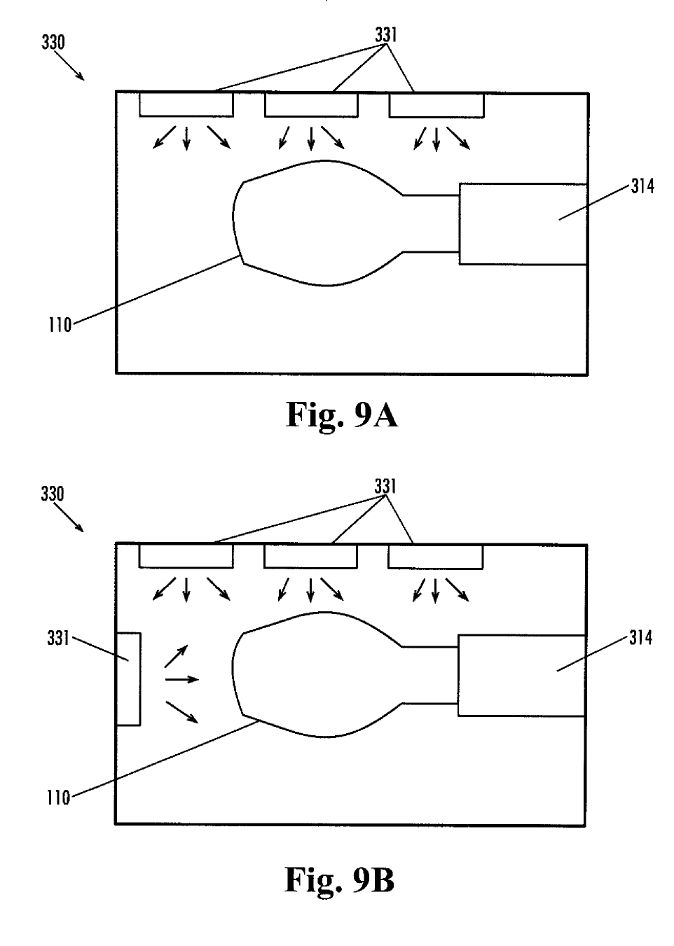

The rotating coated glass bottles 110 then enter an IR irradiator 330 in the accelerated drying zone. The IR irradiator 330 is about 12 feet in length, requiring only 12 seconds for at least partially drying of the coatings on the glass bottles. The IR irradiator 330 is maintained at about 80 kW to about 120 kW. The IR irradiator 330 may in one embodiment include IR bulbs 331 on one or more sides of the glass bottles 110 as they move through the IR irradiator (FIG. 9). For example, in one embodiment the IR bulbs 331 may be located above the glass bottles 110 (FIG. 9A). In another embodiment the IR bulbs 331 may be located both above the glass bottles 110 and on the side of the IR irradiator such that those bulbs on the side of the IR irradiator are directed towards the bottom of the glass bottles (FIG. 9B).

Upon exiting the IR irradiator 330, the glass bottles 110 are exposed to air knives or air nozzles in a cooling zone 332 wherein the at least partially dried coatings are cooled to set the coatings. The coated glass bottles 110 are subsequently inverted back to vertical and released onto a second conveyor belt which transfers the glass bottles to the thermal curing oven, where the glass containers are cured and passed through an oxidizing flame using the same methods described hereinabove (not pictured).

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description therein, may suggestion themselves to those skilled in the art without departing from the spirit of the present invention and/or the scope of the appended claims.

### IV. EXAMPLES

### 1. Example 1

Silane monolayers and tin oxide coatings (30 c.t.u.) were applied to glass containers to determine the influence on the caustic resistance of a polyurethane coating dried and cured simultaneously by microwave energy. The caustic performance of the glass containers was measured. A coating was deemed to have passed the caustic performance test if the coating was not able to be removed from the glass substrate after exposure to a caustic solution. In the following tables, coatings that passed are denoted by a +, coatings that failed are denoted by a −, and coatings that neither passed nor failed are denoted by a +/−.

TABLE 1
Glass container with polyurethane coating

| MW | Time of Caustic Exposure (Hours) | | | | | | | |
|---|---|---|---|---|---|---|---|---|
| Dry/Cure | 0.5 | 1 | 2.5 | 12 | 36 | 72 | 96 | 192 |
| 1 min | + | + | + | − | − | − | − | − |
| 2 min | + | + | + | + | + | − | − | − |
| 3 min | + | + | + | + | + | + | + | − |

TABLE 2
Glass container with primer coating and polyurethane coating

| MW | Time of Caustic Exposure (Hours) | | | | | | | | | |
|---|---|---|---|---|---|---|---|---|---|---|
| Dry/Cure | 0.5 | 1 | 2.5 | 12 | 36 | 72 | 96 | 192 | 272 | 408 |
| 1 min | + | + | + | +/− | +/− | +/− | +/− | +/− | +/− | +/− |
| 2 min | + | + | + | + | + | + | +/− | +/− | +/− | +/− |
| 3 min | + | + | + | + | + | + | + | + | + | + |

TABLE 3
Glass container with tin oxide coating and polyurethane coating

| MW | Time of Caustic Exposure (Hours) | | | | | | | |
|---|---|---|---|---|---|---|---|---|
| Dry/Cure | 0.5 | 1 | 2.5 | 12 | 36 | 72 | 96 | 192 |
| 1 min | + | + | − | − | − | − | − | − |
| 2 min | + | + | + | + | + | − | − | − |
| 3 min | + | + | + | + | + | + | + | − |

TABLE 4
Glass container with tin oxide coating, primer coating,
and polyurethane coating

| MW | Time of Caustic Exposure (Hours) | | | | | | | | | |
|---|---|---|---|---|---|---|---|---|---|---|
| Dry/Cure | 0.5 | 1 | 2.5 | 12 | 36 | 72 | 96 | 192 | 272 | 408 |
| 1 min | + | + | − | − | − | − | − | − | − | − |
| 2 min | + | + | + | + | + | +/− | − | − | − | − |
| 3 min | + | + | + | + | + | +/− | +/− | +/− | − | − |

As shown in Table 1, the caustic durability of the coating increases with an increase in the length of the microwave dry and cure. The caustic durability also improved with the addition of a primer coating on the glass container prior to the addition of the protective organic coating (Table 2). Surprisingly, use of a silane primer coating (Table 2) was superior to primer coatings comprising tin oxide (Table 3) or comprising a combination of silane and tin oxide (Table 4).

### 2. Example 2

The delamination of decorative labels from a caustic soak was compared for thermally cured and microwave cured glass containers. The glass containers were coated with a tin oxide primer and an EcoBrite label was applied. The glass container that was thermally cured showed delamination after a 61 hour soak in 70° C. caustic solution. The glass container that was microwave cured for 4 minutes showed substantially no delamination following a 200 hour soak in 70° C. caustic solution.

### 3. Example 3

The effects of pre-heating, microwave drying, and cooling on the protective organic coating of glass bottles was evaluated. Glass bottles (237 mL and 1 L) were coated using a standard polyurethane coating solution at a temperature in the range of about 19° C. and 22° C. Infrared radiation at a power of about 1500 watts about 0.5 inches from the surface of the glass bottles was used to pre-heat the glass bottles for between 0 and 50 seconds. A hot microwave at a temperature of about 170° C. and a power of 0.75 kW (Table 5) or a power of 1.2-2.4 kW (Tables 6-7) was used to dry the protective organic coatings on the glass bottles. The glass bottles then were cooled using chilled and/or stagnant air for between 0 and 15 seconds.

The temperature and condition of the coatings on the glass bottles was evaluated and is summarized in Tables 5-7. The temperature of the label panel on the glass bottles was measured following each step, and was generally from about 20° C. to about 40° C. higher than the heel of the bottle. The coating condition at the label panel (LP) and the bottom of the bottle were characterized following the microwave drying and cooling as wet (W), tacky (T), slightly tacky (S), or dry (D).

TABLE 5
Effects of pre-heating, microwave drying, and cooling
glass bottles (237 mL)

| | | | Coating | | Coating |
|---|---|---|---|---|---|
| Pre- | Label | Label | Condition | | Condition |
| Heat | Temperature | Temperature | (MW Dry) | Chilled | (Cooled) |
| Time | (Pre-Heat) | (MW Dry) | W, T, S, D | Air | W, T, S, D |
| Sec | ° C. | ° C. | LP, Bottom | Sec | LP, Bottom |
| 10 | 33 | 67 | T, W | 0 | S, T |
| 20 | 43 | 77 | T, T | 0 | S, T |
| 30 | 53 | 87 | S, T | 0 | D, S |
| 30 | 53 | 87 | S, S | 5 | D, S |
| 30 | 56 | 83 | S, S | 10 | D, S |
| 30 | 51 | 81 | S, S | 15 | D, D |

The results of Table 5 compare the condition of the coatings when varying the pre-heating time and the cooling method (chilled or stagnant air). The coating condition improved (i.e., the coating was slightly tacky at both the label panel and heel as compared to tacky and/or wet at the label panel and heel) as the pre-heating time period was increased from seconds to 30 seconds. Use of the chilled air as compared to stagnant air improved the coating condition on the bottom of the bottle (i.e., the coating was dry at both the label panel and bottom upon use of chilled air only as compared to being dry at the label panel while slightly tacky at the bottom upon use of stagnant air only).

TABLE 6
Effects of pre-heating, microwave drying, and cooling glass bottles (1 L)

| | | | | Coating | Coating |
|---|---|---|---|---|---|
| Pre- | Temperature | | Temperature | Condition | Condition |
| Heat | (Pre-Heat) | MW | (MW Dry) | (MW Dry) | (Cooled) |
| Time | ° C. | Power | ° C. | W, T, S, D | W, T, S, D |
| Sec | LP, Heel | % | LP, Heel | LP, Bottom | LP, Bottom |
| 10 | 30, 26 | 60 | 53, 80 | W, T | W, D |
| 10 | 30, 28 | 70 | 52, 100 | T, D | S, D |
| 10 | 29, 29 | 80 | 55, 105 | W, D | W, D |
| 20 | 38, 24 | 60 | 60, 86 | W, T | S, D |
| 20 | 36, 33 | 70 | 60, 100 | W, T | S, D |
| 20 | 37, 33 | 80 | 64, 90 | W, T | S, D |
| 30 | 43, 39 | 60 | 60, 90 | W, T | S, D |
| 30 | 43, 37 | 70 | 97, 90 | T, D | S, D |
| 30 | 44, 36 | 80 | 68, 80 | S, D | D, D |
| 40 | 47, 40 | 60 | 60, 80 | S, D | D, D |
| 40 | 49, 43 | 70 | 60, 100 | S, S | D, D |
| 40 | 49, 42 | 80 | 68, 100 | S, S | D, D |
| 50 | 55, 47 | 60 | 74, 90 | S, S | D, D |
| 50 | 57, 45 | 50 | 75, 65 | S, S | D, D |
| 50 | 57, 46 | 40 | 65, 65 | S, S | D, D |
| 40 | 49, 46 | 40 | 59, 59 | S, S | D, D |
| 40 | 42, 42 | 50 | 63, 52 | S, T | D, D |

The results of Table 6 compare the effect of varying the pre-heating time and microwave drying power on the coating. Short pre-heating time periods and high levels of microwave power produced a significant disparity between both the temperature and coating condition at the label panel and the heel/bottom of the glass containers (e.g., at 10 seconds and 80% power the label panel was 55° C. and had a wet coating while the heel was 105° C. and the bottom had a dry coating). By increasing the pre-heating time periods and decreasing the level of microwave power, there was increased temperature uniformity and coating uniformity (e.g., at seconds and 40% power both the label panel and heel/bottom were 55° C. and dry). In addition, it was observed that with the increased pre-heating time period and the corresponding increase of the container coating temperatures following pre-heating, the required level of microwave power to obtain an equivalent coating condition was reduced.

TABLE 7
Effects of pre-heating, microwave drying, and cooling glass bottles (1 L)

| | | | | Coating | Coating |
|---|---|---|---|---|---|
| Pry- | Temperature | | Temperature | Condition | Condition |
| Heat | (Pre-Heat) | MW | (MW Dry) | (MW Dry) | (Cooled) |
| Time | ° C. | Power | ° C. | W, T, S, D | W, T, S, D |
| sec | LP, Heel | % | LP, Heel | LP, Bottom | LP, Bottom |
| 40 | 49, 42 | 40 | 55, 53 | W, T | T, S |
| 40 | 49, 42 | 40 | 58, 52 | W, T | S, S |
| 40 | 48, 41 | 50 | 58, 50 | S, S | S, VS |
| 40 | 46, 40 | 50 | 67, 60 | D, D | |
| 50 | 51, 44 | 40 | 64, 59 | S, S | VS, D |
| 50 | 56, 46 | 40 | 67, 61 | D, D | |
| 50 | 51, 44 | 50 | 70, 54 | T, T | S, S |
| 50 | 52, 48 | 50 | 70, 55 | D, D | |

The results shown in Table 7 further illustrate the relationship between the pre-heating time period and the microwave power levels. As the pre-heating time period was increased, the temperatures of the container coatings at both the heel and the label also increased, thereby requiring less microwave power in order to obtain adequate levels of dryness.

Accordingly, it appears that the desirable temperature of the glass containers upon entering the microwave should be in the range of about 45° C. to about 50° C. In addition, the results indicate that by increasing the pre-heating temperature, the required microwave power decreases by about 40% to about 50%. Not wishing to be bound by any theory, it is believed that microwave drying at higher power levels results in non-uniform temperatures in the coatings on the bottles and the subsequent creation of defects.

### 4. Example 4

Previous experiments have indicated that if the bottle temperature is greater than about 70° C., the coating on the glass surface can be considered dry (data not shown). A series of experiments were conducted to identify the power levels required from an IR irradiator and microwave to achieve both a bottle temperature of 70° C. and a dry coating.

Glass bottles were coated using a standard polyurethane coating solution at a temperature in the range of about 19° C. and 22° C. Infrared radiation at a power of about 87 kW or 104 kW was used to pre-heat and/or dry the glass bottles for between 0 and 50 seconds. A hot microwave with a power output of 0 kW, 3 kW, 6 kW, or 9 kW was used to dry the protective organic coatings on the glass bottles. The temperature and condition of the coatings on the glass bottles was evaluated and is summarized in Table 8.

| IR Power | Microwave Power | Bottle Temperature | Surface condition |
|---|---|---|---|
| (kW) | (kW) | (° C.) | (Wet/Dry/Bubbles) |
| 87 | 0 | 55 | Wet |
| 87 | 9 | 69 | Dry |
| 104 | 0 | 72 | Dry |
| 104 | 3 | 77 | Dry |
| 104 | 6 | 85 | Dry; Bubbles |

The results indicated that 9 kW microwave power without use of an IR irradiator to preheat the glass bottles was insufficient to dry the coating and obtain the desired bottle temperature of 70° C. (data not shown); however, by first pre-heating the glass bottles with an IR irradiator at a power output of 87 kW before exposing the bottles to 9 kW microwave power resulted in both a dry coating and a satisfactory bottle temperature. Increasing the IR power output to 104 kW provided both adequate drying and bottle temperature without requiring the additional use of the microwave to effectively dry the coating. When both the microwave power and IR power were increased to 6 kW and 104 kW, respectively, an excessively high bottle temperature and dry coating resulted. Not wishing to be bound by any theory, it is believed that the excessive temperature exhibited by this experiment caused the coating to dry too rapidly, resulting in coating defects (bubbles).

### 5. Example 5

At a base fluorosurfactant concentration of 0.05 wt % of the polyurethane protective coating solution, a smooth, defect free coating can be produced on glass bottles by using a slow drying mechanism. In such embodiments the coating/bottle temperature should be raised slowly from room temperature to 70° C. over a period of not less than 2 minutes and optimum drying will occur over a period of 4-8 minutes.

At this fluorosurfactant level, a smooth, a defect free coating was not able to be produced upon accelerated drying using IR radiation. In such embodiments, the coating developed visible defects (orange peel) after 18 seconds to 1.5 minutes of exposure (data not shown). By increasing the fluorosurfactant levels to between 0.1 and 0.30 wt % of the polyurethane protective coating solution, more particularly from between 0.10 and 0.15 wt %, accelerated drying using IR radiation for 18 seconds produced a smooth, defect free coating on glass bottles.

### 6. Example 6

At a base anthraquinone dye concentration of 0.03 wt. % of the polyurethane protective coating solution, the required power level of the IR heating zone required to dry the coating was from 50-68% of maximum power (total power=173 kW). At this power level the resultant average temperature of the heating chamber exit was 420° C. and the resultant bottle temperature was 72° C.

When the base anthraquinone dye concentration was increased to 0.06 wt. % of the polyurethane protective coating solution, the required power level of the IR heating zone required to dry the coating was from 44-68% of maximum power (total power=173 kW). At this power level the resultant temperature of the heating chamber exit was 387° C. and the resultant bottle temperature was 72° C.

This experiment illustrates that increasing the concentration of anthraquinone dye in the protective organic coating can reduce the amount of energy required to heat and dry the coating.

It should be apparent that the foregoing relates only to particular embodiments of the present invention, and that numerous changes and modifications may be made therein without departing from the scope of the invention as defined by the following claims and equivalents thereof.

We claim:

1. An integrated method for coating glass containers comprising the steps of:
obtaining a glass container;
applying a protective organic coating to the glass container;
at least partially drying the protective organic coating on the glass container using accelerated drying; and thereafter curing the protective organic coating on the glass container.

2. The method of claim 1, wherein the accelerated drying comprises a process capable of at least partially drying the protective organic coating on the glass container in a time period of less than about 60 seconds.

3. The method of claim 1, wherein the accelerated drying comprises a process capable of at least partially drying the protective organic coating on the glass container in a time period of less than about 30 seconds.

4. The method of claim 1, wherein the accelerated drying comprises a form of electromagnetic radiation.

5. The method of claim 1, wherein the accelerated drying is selected from the group consisting of radio waves, microwaves, infrared radiation, and a combination thereof.

6. The method of claim 1, wherein the accelerated drying comprises microwaves.

7. The method of claim 6, further comprising the step of pre-heating the coated glass container prior to at least partially drying the protective organic coating on the glass container.

8. The method of claim 7, wherein the step of pre-heating the coated glass container comprises exposing the glass container to an energy source comprising thermal, IR radiation, microwaves, RF, or combinations thereof.

9. The method of claim 7, wherein the step of pre-heating the coated glass container comprises pre-heating the coated glass container to a temperature in the range of about 25 to about 60° C.

10. The method of claim 7, wherein the step of pre-heating the coated glass container comprises pre-heating the coated glass container to a temperature in the range of about 35 to about 55° C.

11. The method of claim 6, wherein the step of at least partially drying comprises exposing the glass container to microwave energy for a time in the range of about 6 to about 20 seconds.

12. The method of claim 6, wherein the source of microwave energy comprises a microwave having an output power in the range of about 0.3 to about 300 kilowatts.

13. The method of claim 6, wherein the source of the microwave energy comprises a hot microwave at a temperature in the range of about 150 to about 200° C.

14. The method of claim 6, wherein the source of microwave energy comprises a first and a second choke area to prevent the release of the microwaves outside of the source of the microwave energy.

15. The method of claim 1, wherein the accelerated drying comprises infrared radiation.

16. The method of claim 15, wherein the step of at least partially drying comprises exposing the glass container to infrared radiation for a time in the range of about 8 to about 20 seconds.

17. The method of claim 15, wherein the source of infrared radiation comprises an infrared irradiator operating at a power of about 80 to about 120 kW.

18. The method of claim 15, further comprising the step of cooling the protective organic coating on the glass container.

19. The method of claim 1, further comprising the step of applying a label to the glass container prior to the step of applying the protective organic coating to the glass container.

20. The method of claim 1, wherein the glass container is obtained having a primer coating thereon.

21. The method of claim 20, wherein the primer coating comprises a silane composition and optionally a surface-treatment composition.

22. The method of claim 21, wherein the silane composition comprises a monoalkoxysilane, a dialkoxysilane, a trialkoxysilane, a tetralkoxysilane, or a combination thereof.

23. The method of claim 21, wherein the primer coating further comprises a surface-treatment composition comprising a stearate.

24. The method of claim 19, wherein the label comprises a decorative organic label.

25. The method of claim 1, wherein the protective organic coating comprises a polyurethane.

26. The method of claim 1, wherein the protective organic coating is substantially evenly distributed on the glass container.

27. The method of claim 1, wherein the protective organic coating further comprises a defoamer in an amount sufficient to create a textured surface on the glass container.

28. The method of claim 1, wherein the step of curing comprises exposing the glass container to an energy source comprising thermal, IR radiation, UV radiation, microwaves, RF, or combinations thereof.

29. The method of claim 1, wherein the step of curing comprises exposing the glass container to microwave energy for a time in the range of about 2 to about 5 minutes.

30. The method of claim 1, further comprising the step of cooling the protective organic coating on the glass container.

31. The method of claim 1, further comprising the step of oxidizing the protective organic coating on the glass container.

32. The method of claim 1, further comprising the step of pre-heating the coated glass container prior to applying the protective organic coating on the glass container.

33. The method of claim 32, wherein the step of pre-heating the coated glass container comprises exposing the glass container to an energy source comprising thermal, IR radiation, microwaves, RF, or combinations thereof.

34. The method of claim 32, wherein the step of pre-heating the coated glass container comprises pre-heating the coated glass container to a temperature in the range of about 30 to about 55° C.

35. The method of claim 1, wherein the method is continuous.

36. The method of claim 1, wherein the steps of applying a protective organic coating to the glass container, at least partially drying the protective organic coating on the glass container using accelerated drying, and thereafter curing the protective organic coating on the glass container are repeated at a second location after the coated glass container has been used and returned by a consumer.

37. The method of claim 36, wherein the second location comprises a mobile coating unit.

38. The method of claim 36, wherein the coated glass container that has been used and returned by a consumer comprises scuffs and/or blemishes in the protective organic coating prior to applying the protective organic coating to the glass container.

39. A coated returnable glass container produced by the method of claim 1.

40. A coated returnable glass container comprising a primer coating and a protective organic coating, wherein the protective organic coating is dried using accelerated drying.

41. The coated returnable glass container of claim 40, further comprising an organic decorative label between the primer coating on the glass container and the protective organic coating.

42. An apparatus for coating glass containers comprising:
a first optional pre-heating zone for pre-heating the glass container;
an organic coating applicator for applying a protective organic coating to the glass container;
a second optional pre-heating zone for pre-heating the glass container;
an accelerated drying zone for at least partially drying the protective organic coating on the glass container using accelerated drying;
an cooling zone for cooling the protective organic coating on the glass container; and
a curing zone for curing the at least partially dried protective organic coating on the glass container.

43. The apparatus of claim 42, further comprising a decorator for applying a decorative label to the glass container prior to applying the protective organic coating to the glass container.

44. The apparatus of claim 42, further comprising an oxidizing zone for at least partially oxidizing the protective organic coating on the glass container.

45. The apparatus of claim 42, further comprising a conveyor belt and a plurality of chucks for transporting the glass container through the first optional pre-heating zone, the organic coating applicator, the second optional pre-heating zone, the accelerated drying zone, the cooling zone, and the curing zone.

46. The apparatus of claim 45, wherein the conveyor belt and the plurality of chucks comprise microwave-compatible materials.

47. The apparatus of claim 46, wherein the microwave-compatible materials comprise a material selected from the group consisting of Teflon, glass-filled Teflon, and PEEK.

48. The apparatus of claim 42, wherein the accelerated drying zone at least partially dries the protective organic coating on the glass container so that the integrity of the protective organic coating on the glass container is maintained during subsequent handling of the glass container.

49. The apparatus of claim 42, wherein the accelerated drying zone comprises a microwave oven.

50. The apparatus of claim 42, wherein the accelerated drying zone comprises an infrared irradiator.

51. The apparatus of claim 42, wherein the organic coating applicator comprises a sprayer, a dip tank, a roller, a silk-screener, or a combination thereof.

52. The apparatus of claim 42, wherein the optional first and/or second pre-heating zone comprises an energy source selected from the group consisting of thermal, IR radiation, microwaves, RF, and combinations thereof.

53. The apparatus of claim 42, wherein the curing zone comprises a lehr, a oven, or a combination thereof.

54. The apparatus of claim 42, wherein the apparatus comprises a mobile unit.
